(19) United States
(12) Patent Application Publication
(10) Pub. No.: US 2009/0037230 A1
(43) Pub. Date: Feb. 5, 2009

(54) System for Electronic Application of Discounts to Insurance Policies

(76) Inventors: Thomas J. Tracy, Pittston, PA (US); Charles T. Schaefer, Blue Bell, PA (US)

Correspondence Address: ZALE Patent Law, 434 Lackawanna Ave., Suite 200, Scranton, PA, 18503-2053, US

(21) Appl. No.: 12/131,926

(22) Filed: Jun. 3, 2008

Related U.S. Application Data
(60) Provisional application No. 60/949,215, filed on Jul. 11, 2007.
(60) Provisional application No. 61/025,598, filed on Feb. 1, 2008.

(51) Int. Cl. G06Q 40/00

(52) U.S. Cl. 705/4

(57) ABSTRACT

A method for electronic validation and application of available, standard discounts to eligible automobile and property insurance policies of an insured which will significantly reduce the administrative cost of the paper-intensive processing methods utilized presently by property and casualty insurance carriers. The system employs a validation system which securely collects information from verification entities such as schools for academic discounts and fire and security monitoring companies for homeowner's discounts. The validation system then authenticates the source of the collected information. Once authenticated, this information is processed and provided to insurance carriers electronically. The insurance carriers then provide the discount to the insured's policy.

### CROSS REFERENCE TO RELATED APPLICATIONS

The present application is related to, and claims priority from U.S. Provisional Patent Application “Method for Electronic Application of Policyholder Discounts to Property and Casualty Insurance Policies” Ser. No. 60/949.215 filed Jul. 11, 2007 and U.S. Provisional Patent Application “Method for Electronic Application of Policyholder Discounts to Property and Casualty Insurance Policies” Ser. No. 61/025.598 filed Feb. 1, 2008 both having the same inventorship as this application.

### FEDERALLY SPONSORED RESEARCH

None

### SEQUENCE LISTING

None

### BACKGROUND OF THE INVENTION

1. Field of the Invention

The present invention relates to an automated system for acquiring and reporting discount information to insurance companies.

2. Discussion of Related Art

In the present Property and Casualty Insurance environment, the insured, or policyholder, is entitled to certain policy discounts if they meet requirements (“criteria”) set by the insurance companies. Many insurance companies share the same or similar criteria. Among the most prevalent discount in the automobile insurance segment is the Good Student Discount, where the 16-25 year old named insured, or the 16-25 year old child of a named insured meets certain academic criteria set forth by the individual insurance company.

Discounts can also be applied to policies for such things as driver training courses, resident students, and students who attend schools more than 100 miles from home.

In addition to academic-based discounts, policyholders who are age 55 and over may be afforded a reduced premium for attending a defensive driver course.

The insurance carriers also allow discounts for home insurance if the insured has installed fire and/or security monitoring systems, such as those offered by ADT and Brinks. This discount applies as long as the insured has an active monitoring policy. Therefore, the insurance company must periodically verify that a monitoring subscription is active.

The current process for applying the aforementioned discounts is as follows:
1) The insured verbally notifies an insurance agent (“Agent”) that the insured may be eligible for a specific discount.
2) The Agent provides a form to the insured to fill out and execute, or requests a copy of the student transcript.
3) The insured takes the executed form to a verification entity (the school for academic discounts or a monitoring company for fire/security discounts) for verification.
4) The verification entity fills in and verifies the discount criteria.
5) The insured submits the verified form and/or possibly additional paper documentation (report cards, certificates, invoices, etc.) to the Agent.
6) The Agent, in turn, submits said documentation via fax or mail to the policy administration section of the insurance carrier.
7) The policy administration section may then electronically scan said documentation into its computer archives via an imaging and indexing process or files said documentation manually. This allows the Agent to pass on the discount to the insured.
8) Prior to the renewal date of the policy, the insurance carrier notifies the insured, and in many cases, the Agent, that current proof of eligibility for the discount is again required.
6) The process then continues at step 2.

The disadvantages of the current process are as such:
1) The insurance carriers, through the process described above, incur significant administrative costs associated with the processing of paper documentation needed to validate the discounts.
2) The insurance carriers are potentially subject to fraud due to the submission of inauthentic documentation.
3) The insurance carriers may forego premiums due to the misapplication of discounts from inauthentic documentation.
4) The insured spends considerable time and effort to obtain proof of eligibility from the verification entity (for example: school registrar, fire monitoring service, etc.).
5) The Agent, in turn, spends considerable time, effort, and thus, administrative expense, in obtaining said documentation from the insured.
6) The insured must continually provide report cards, invoices, etc. to the insurance carriers for each policy renewal.

There is currently a need for a system which automates the insurance discount process, reduces labor and retains a sufficient level of authentication.

### SUMMARY OF THE INVENTION

One embodiment of the present invention is a method for electronic application of discounts to insurance policies comprising:
a) providing a discount form to an insured to complete, said form having instructions to send the form to an validation system, said form also identifying the insured, the insurance policy, the discount criteria and insured's consent to retrieve said criteria from verification entity;
b) executing, by the insured, the discount form;
c) sending, by the insured, the executed discount form to a verification entity;
d) filling in, by the verification entity, the discount criteria on the executed discount form;
e) electronically sending, by the verification entity, the filled-in discount form to the validation system listed on the discount form;
f) verifying, by the validation system, using a unique identifier specific to said verification entity, that the verification entity was the actual sender of the discount form,
g) processing said discount form using electronic equipment to automatically extract eligibility information;
h) storing the eligibility information in a PRR database;
i) relaying said eligibility information electronically to an insurance company for application of said discounts; and
j) allowing specific insurance companies on-line access to the eligibility information in the PRR database for electronic access by insurance company for present and future applications of the discounts to said insurance policies.

### OBJECTS OF THE INVENTION

It is an object of the present invention to provide a system of applying insurance discounts which reduces administrative cost of processing discounts.

It is another object of the present invention to provide a system which reduces fraudulent documentation allowing insurance companies to capture premium that may otherwise be lost through the application of invalid discounts.

It is another object of the present invention to provide a system which reduces labor involved in applying insurance discounts.

It is another object of the present invention to provide a system which automates the insurance discount verification but retains a sufficient level of authentication.

### BRIEF DESCRIPTION OF THE DRAWINGS

The advantages of the instant disclosure will become more apparent when read with the specification and the drawings, wherein:

FIGS. 1A and 1B together represent a flow chart showing the work flow of applying insurance discounts in a prior art system.

FIG. 2 is a diagram of the work flow of FIGS. 1A and 1B showing how items are passed between various entities of the system.

FIG. 3 is a flow chart showing the work flow of an automated system for applying insurance discounts according to one embodiment of the present invention.

FIG. 4 is a diagram of the work flow of FIG. 3 showing how items are passed between various entities of the system.

### DETAILED DESCRIPTION OF THE INVENTION

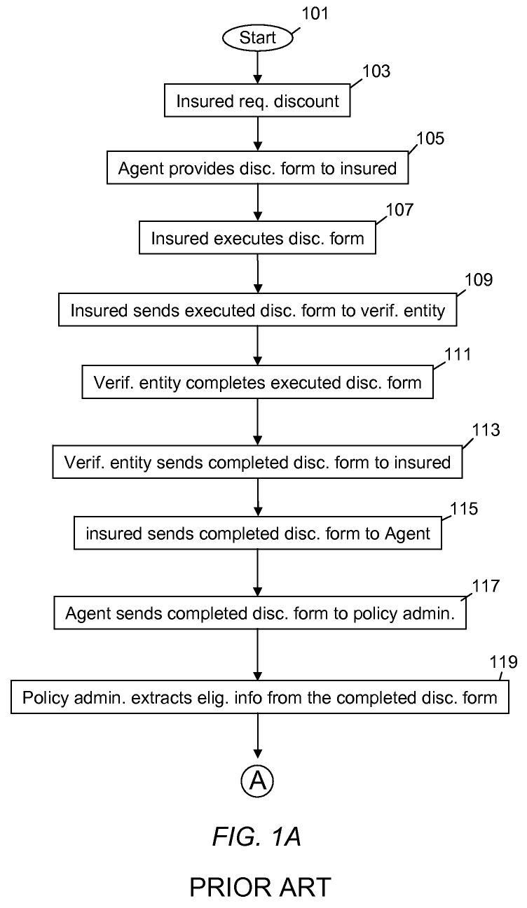

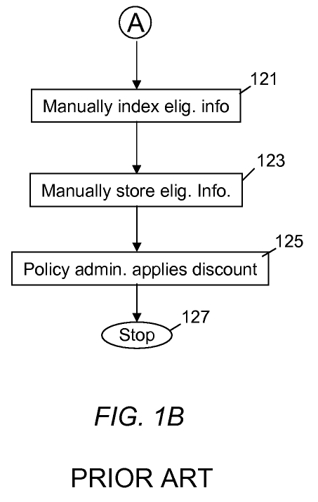

FIGS. 1A and 1B together represent a flow chart showing the work flow of applying insurance discounts in a prior art system.

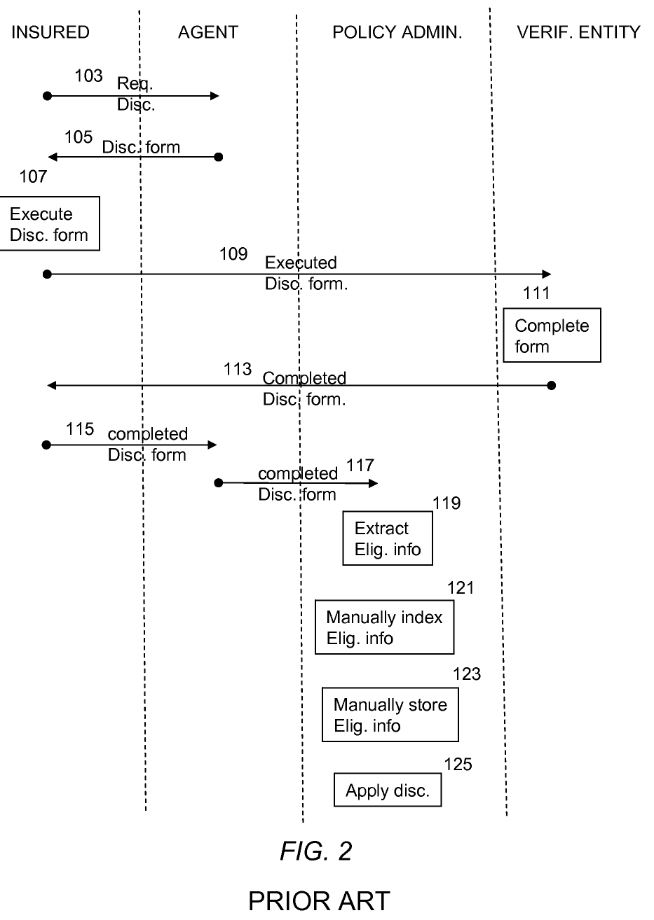

FIG. 2 is a diagram of the work flow of FIGS. 1A and 1B showing how items are passed between various entities of the system.

The prior art system will be described with reference to both FIGS. 1 and 2, moving from top to bottom of each. The process starts at step 101. In step 103 the insured requests an insurance discount from an Agent.

In step 105, the insurance Agent provides a discount form to the insured.

In step 107, the insured fills out the appropriate information, signs and dates the form. This includes a release signed by the insured allowing the confidential information to be released.

In step 109, the insured either brings, faxes, mails, e-mails or otherwise provides the executed discount form to a school for verification of academic achievement which is a criteria for a ‘good student’ discount for auto insurance. The school would be considered a ‘verification entity’.

In step 111, the verification entity completes the executed discount form.

In step 113, the verification entity sends the completed discount form to the insured.

The insured then forwards the completed discount form to the Agent in step 115.

In step 117, the Agent forwards the completed discount form to policy administration of the insurance carrier.

Policy administration then extracts the relevant eligibility information from the completed discount form in step 119.

The process then continues at the circle marked “A” on FIG. 1B.

In step 121, the eligibility information and other documents are manually indexed.

In step 123, the eligibility information and associated documents are manually stored in files.

In step 125, policy administration uses the extracted eligibility information to apply the discount.

The process ends at step 127.

Alternatively, the verification entity may be a fire or security monitoring company to verify that there is a current fire monitoring contract in place. This would provide the insured a discount in their homeowner's policy.

There also may be a number of other verification entities to directly verify criteria used in applying discounts.

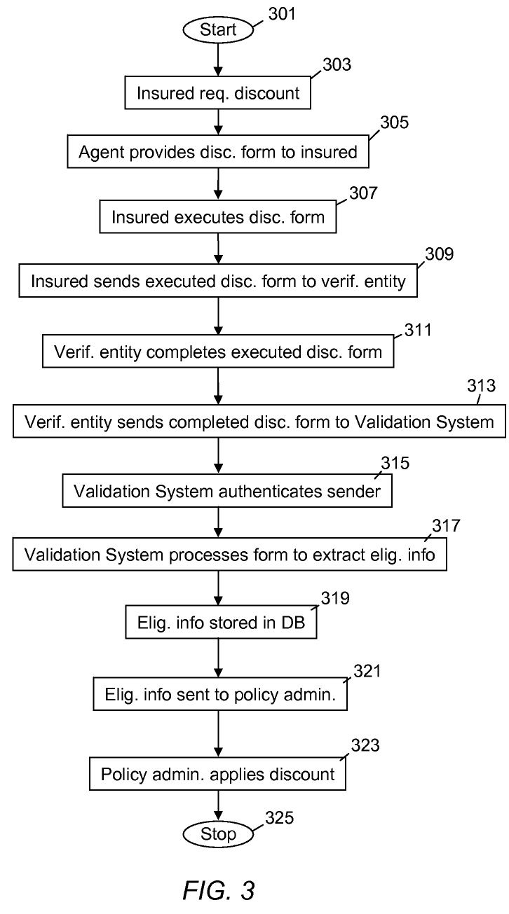

FIG. 3 is a flow chart showing the work flow of an automated system for applying insurance discounts according to one embodiment of the present invention.

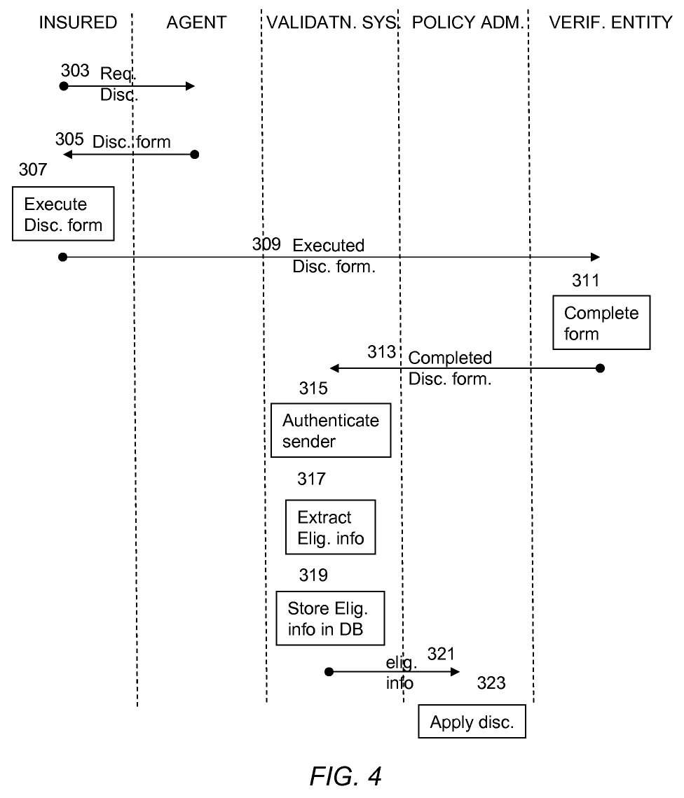

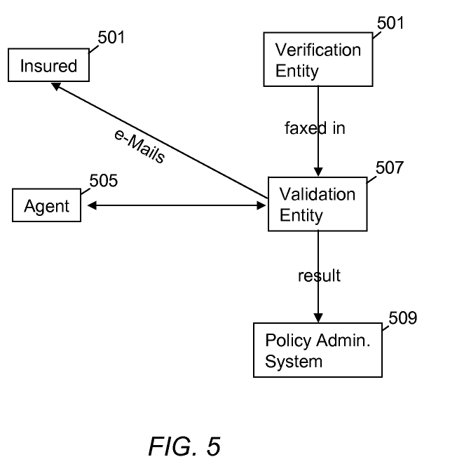

FIG. 4 is a diagram of the work flow of FIG. 3 showing how items are passed between various entities of the system.

This embodiment of the novel system will be described with reference to both FIGS. 3 and 4, moving from top to bottom of each figure. The process starts at step 301. In step 303 the insured requests an insurance discount from an Agent.

In step 305, the Agent provides a discount form to the insured.

In step 307, the insured executes the discount form and fills out the appropriate information. A release is signed by the insured allowing the confidential information to be released.

In step 309, the insured either brings, faxes, mails, e-mails or otherwise provides the executed discount form to a school for verification of academic achievement which is a criteria for a ‘good student’ discount for auto insurance. The school would be considered a ‘verification entity’.

In step 311, the verification entity completes the discount form.

In step 313, the verification entity sends the completed discount form to an validation system. Presently, the preferred methods of sending the completed discount form is by fax, or e-mail ID.

In step 315, the validation system has the capability of receiving the telephone number or e-mail ID of the fax machine or entity sending the completed discount form. This is acquired and compared to the fax number for the verification entity. If they match, the fax is authentic. If not, other means of authentication could be employed.

One simple means would be to manually call the verification entity to verify the fax number or e-mail ID received. It may be a new fax number which is not yet known to the validation system.

Once the completed form is authenticated, in step 317 the completed form is processed to extract the eligibility information. One such method is by optical scanning and optical character recognition.

In step 319, the eligibility information is stored in a database (the “PRR Database”) of the validation system.

This eligibility information is sent to the insurance carrier in step 321.

The eligibility information is analyzed in step 323 to determine if the discount applies. If it does, the insurance carrier then modifies the premiums due for the insured to apply the discount.

The process ends at step 325.

In an alternative embodiment, the electronic communication may be through the Internet in which the IP address or MAC code of the sending unit may be used to verify the source of the transmission.

Also, in another embodiment, the validation system may make the database available to the insurance carrier. In this case, the insurance carrier may simply check the eligibility information in the database when necessary. This may be during renewal, change in the policy, etc. Therefore, the insurance carrier could more efficiently access the required information in a trusted environment.

Therefore, the input to the PRR Database is indirectly built from requests from the insurance agent and/or the insurance carrier to the appropriate school, or service entity.

In an alternative embodiment, input to the PRR Database can be provided manually through an input screen from the verification entity (a school, monitoring company, service entity, etc.)

The input may be provided via fax, as stated above or electronic file transfer, such as through File Transfer Protocol (FTP).

The electronic file format is preferably a standard format, such as Extensible Markup Language (XML).

The information generally required for an academic discount would be the student's, or policyholder's name, address, the grades from the prior marking period, or the student's class ranking.

This information is stored in the PRR Database for subsequent use by insurance agents and insurance carriers to determine a “Good Student” on the family auto policy, the policy of the named insured under 25 years of age, or other policies eligible for said home security or like discounts.

In another embodiment, the insurance agent and insurance carrier can access the PRR Database through an inquiry screen, or through a recursive call to the PRR Database for each student's grade, class ranking information, or other data related to the continued qualifications for said discounts.

The present invention allows the insurance carriers and insurance agents the ability to interactively obtain a certified copy of scholastic achievement and class ranking, or pertinent qualifying data from the PRR Database. If the student/policyholder record is not on the PRR Database, the system will request from the school, or service entity, the information required to determine if the student is a “Good Student”, or if the policyholder meet general criteria sent to the verification entity.

In addition, requests for individual insured may be made to the verification entity if the Student or policyholder is not on the PRR Database.

This system may operate as set forth below.

An automated message is sent to a specified verification entity. This message could be by email, fax, file transfer, or other means to a prestored address of this verification entity. This prestored address may be an e-mail address, IP address, fax number, screen name, etc.

This message has instructions to connect to (click on) a URL which takes the Registrar to a web page connected to the PRR Database of the Validation system. The request is then updated by the verification entity (school) by answering the questions specified by the insurance carrier to determine if the insured (student) is a “Good Student” and qualifies for the (academic) discount.

The information provided to the web page is stored in the PRR Database and sent to the insurance carrier as an “Official Response”.

At policy renewal, an automated e-mail will be sent to the verification entity, to re-validate the information determining if a discount applies. If current information is not on the PRR Database for the insured, the information is then re-processed by the insurance carrier as set forth above.

The renewal procedure has fewer steps that the initial verification. This works to the advantage of the insurance carriers with increased labor savings.

The system may also be embodied as described in connection with FIG. 5 below.

FIG. 5 is a block diagram indicating the entities interacting in the present invention.
1. The insured 501 instructs the insurance company agent 505 they are eligible for a discount.
2. The agent 505 initiates a request to generate an order for the appropriate discount form.
3. The validation system 507. Validation system 507 creates the form with tracking and allow agent 505 to generate forms or emails and send them directly to the insured 501.
4. The insured 501 gives the executed forms to a verification entity 503.
5. The verification entity 503 completes forms and returns them to the validation system 507.
6. The validation system 507 evaluates the form via optical character recognition (OCR) and error correction to extract information.
7. The validation system 507 notifies a policy administration system 609 of the insurance carrier of the result.
8. The policy administration system 609 applies the discount.

The above embodiment is presented for illustration purposes, however, many different embodiments could be employed which are variations of the present invention and all fall under the scope of this application.

What is claimed is:

1. A method for electronic application of discounts to insurance policies of an insured comprising:
a) providing a discount form to said insured to complete, said form having instructions to send the form to an validation system, said form also identifying the insured, the insurance policy, the discount criteria and insured's consent to retrieve said criteria from verification entity;
b) executing, by said insured, the discount form;
c) sending, by said insured, the executed discount form to a verification entity;
d) filling in, by the verification entity, the discount criteria on the executed discount form;
e) electronically sending, by the verification entity, the filled-in discount form to the validation system listed on the discount form;
f) verifying, by the validation system, using a unique identifier specific to said verification entity, that the verification entity was the actual sender of the discount form,
g) processing said discount form using electronic equipment to automatically extract eligibility information;
h) storing the eligibility information in a PRR database;
i) relaying said eligibility information electronically to an insurance company for application of said discounts; and
j) allowing specific insurance companies on-line access to the eligibility information in the PRR database for electronic access by insurance company for present and future applications of the discounts to said insurance policies.

2. The method for electronic application of discounts of claim 1, wherein verification entity is an education institution.

3. The method for electronic application of discounts of claim 1, wherein the verification entity is an entity which monitors a building for signs of a fire.

4. The method for electronic application of discounts of claim 1, wherein the verification entity is an entity which monitors a building for signs of an intrusion.

5. The method for electronic application of discounts of claim 1, wherein in the step of verifying, the unique identifier is a known fax number.

6. The method for electronic application of discounts of claim 1, wherein in the step of verifying, the unique identifier is a known IP address.

7. The method for electronic application of discounts of claim 1, wherein in the step of verifying, the unique identifier is a known e-mail address.

8. The method for electronic application of discounts of claim 1, wherein the step of relaying said eligibility information electronically comprises the step of automatically faxing the eligibility information.

9. The method for electronic application of discounts of claim 1, wherein the step of relaying said eligibility information electronically comprises the step of e-mailing the eligibility information.

10. The method for electronic application of discounts of claim 1, wherein the step of relaying the eligibility information electronically comprises the step of relaying the eligibility information using instant messenger communications software.

11. The method for electronic application of discounts of claim 1, wherein the step of relaying said eligibility information electronically comprises the step of sending eligibility information via Internet communication.

12. The method for electronic application of discounts of claim 1, wherein the step of relaying said eligibility information electronically comprises the step of sending the eligibility information via wireless communication.

13. The method for electronic application of discounts of claim 1, wherein the step of relaying said eligibility information electronically comprises the step of sending eligibility information via wireless text communication.

14. The method for electronic application of discounts of claim 1, wherein the step of processing said discount form using optical recognition equipment comprises the steps of:
a) performing optical character recognition, then
b) comparing the recognized characters to known phrases.
